(19) United States
(12) Patent Application Publication
(10) Pub. No.: US 2026/0089676 A1
(43) Pub. Date: Mar. 26, 2026

(54) METHOD FOR LOCATING USER EQUIPMENT AROUND A VEHICLE

(71) Applicant: Continental Automotive Technologies GmbH, Hannover (DE)

(72) Inventors: Clément FERRY, Villeneuve Tolosane (FR); Brahim ALOUI, Toulouse (FR); Grégory SIGUIER, Miremont (FR)

(73) Assignee: Continental Automotive Technologies GmbH, Hannover (DE)

(21) Appl. No.: 19/320,063

(22) Filed: Sep. 5, 2025

(30) Foreign Application Priority Data
Sep. 24, 2024 (FR) FR2410153

(51) Int. Cl. H04W 64/00; H04B 7/06

(52) U.S. Cl. CPC H04W 64/00; H04B 7/0632

(57) ABSTRACT

The invention relates to a method for locating a user equipment around a motor vehicle, in particular comprising the steps of reception (E4A), by the left antenna of a specific communication module, of a signal sent by the user equipment, of computation (E5A) of the power of the signal received by the left antenna, of reception (E4B), by the right antenna of a specific communication module, of a signal sent by the user equipment, of calculation (E5B) of the strength of the signal received by the right antenna, and of determination (E7) of the location of the user equipment from the distances estimated for at least two generic communication modules each weighted by its corresponding weighted quality index.

### CROSS-REFERENCE TO RELATED APPLICATIONS

This application claims priority to FR2410153, filed Sep. 24, 2024, the contents of such application being incorporated by reference herein.

### FIELD OF THE INVENTION

The present invention relates to the field of motor vehicles and more particularly to a method for locating a user equipment around a motor vehicle, to a vehicle implementing this method and to a system comprising such a vehicle and a user equipment.

### BACKGROUND OF THE INVENTION

In a motor vehicle, it is known to locate or pre-locate a user equipment (a key, key card or smart phone for example) using Bluetooth technology, and in particular Bluetooth Channel Sounding.

One known solution for estimating the distance between the vehicle and the user equipment consists in setting up a communication with the user equipment and in measuring the strength of the signals received from the user equipment, the distance being proportional to the measured strength. This method may sometimes be inaccurate because the strength of the signals varies depending on their paths, which may differ depending on reflections of the signals.

Another known solution consists in setting up a communication with the user equipment and in calculating the time of flight of the signals, the distance being deducted from the round-trip time of flight because the speed of the signals is known. This method may sometimes be inaccurate in Bluetooth Channel Sounding because the bandwidth of the signals is too narrow.

Another known solution consists in setting up a communication with the user equipment and determining the phase of the signals sent by the user equipment and then determining the average phase slope as a function of the frequency of the signals on the channels used in the protocol Bluetooth Channel Sounding or indeed applying a specific algorithm to the determined phase values, for example a MUSIC algorithm (MUSIC being the acronym of Multiple Signal Classification) known per se. However, this type of solution may be inaccurate at times.

Furthermore, in all the known solutions, a low sensitivity on the part of the receiver used in the vehicle, environmental noise or frequency desynchronization between the transmitter and the receiver may lead to an increase in the inaccuracy of the measurements made on the signals.

A simple, reliable and efficient solution allowing these drawbacks to be at least partly overcome would therefore be advantageous.

### SUMMARY OF THE INVENTION

To this end, the first aspect of the invention is a method for locating a user equipment around a motor vehicle, said vehicle comprising at least four communication modules designated the “generic” communication modules, at least two of which are mounted in the left-hand part of the vehicle and at least two of which are mounted in the right-hand part of the vehicle, and a communication module that is designated the “specific” communication module, each generic communication module comprising at least one antenna, for example a single antenna or a diversity of antennas, and being configured to communicate with said user equipment, the specific communication module being mounted on the longitudinal axis of the vehicle and comprising a first antenna designated the “left” antenna and a second antenna designated the “right” antenna, said left antenna being configured to radiate over 180° and cover the left-hand part of the vehicle, said right antenna being configured to radiate over 180° and cover the right-hand part of the vehicle, the specific communication module being configured to communicate with said user equipment, said method comprising the steps of:
reception of a signal transmitted by the user equipment by at least two generic communication modules, including a first generic communication module and a second generic communication module,
estimation, for each generic communication module, of a distance of the user equipment from the center of the vehicle,
calculation of a quality index of the received signal for each generic communication module, including a first quality index of the signal received by the first generic communication module and a second quality index of the signal received by the second generic communication module,
reception, by the left antenna of the specific communication module, of a signal sent by the user equipment,
calculation of the signal strength received by the left antenna,
reception, by the right antenna of the specific communication module, of a signal sent by the user equipment,
calculation of the signal strength received by the right antenna,
if the strength of the received signal of the left antenna is greater than the strength of the received signal of the right antenna, weighting by a first coefficient the quality indices calculated for the one or more generic communication modules located in the left-hand part of the vehicle and weighting by a second coefficient the quality indices calculated for the one or more generic communication modules located in the right-hand part of the vehicle, the first coefficient being greater than the second coefficient,
if the strength of the received signal of the right antenna is greater than the strength of the received signal of the left antenna, weighting by the first coefficient the quality indices calculated for the one or more generic communication modules located in the right-hand part of the vehicle and weighting by the second coefficient the quality indices calculated for the one or more generic communication modules located in the left-hand part of the vehicle,
determination of the location of the user equipment from the distances estimated for at least two generic communication modules, each distance being weighted by its corresponding weighted quality index.

The method according to an aspect of the invention makes it possible to weight the quality indicators depending on whether the user equipment is to the right or to the left of the vehicle, in order to improve the weight of the locations calculated for each generic communication module located on the same side of the vehicle and thus improve the overall location of the user equipment with respect to the vehicle.

Preferably, the first coefficient is equal to 1 and the second coefficient is equal to 0.5. These values could be different depending on the weight that it is desired to give to the quality indicators of the one or more communication modules located on the same side of the vehicle as the user equipment.

Preferably, the location of the user equipment is determined by bilateration and tracking for two generic communication modules or by trilateration for three generic communication modules, in a manner known per se.

Another aspect of the invention is a computer program product, characterized in that it comprises a set of program code instructions which, when they are executed by one or more processors, configure the one or more processors to implement a method such as presented above.

Another aspect of the invention is a motor vehicle comprising at least four communication modules designated the “generic” communication modules, at least two of which are mounted in the left-hand part of the vehicle and at least two of which are mounted in the right-hand part of the vehicle, and a communication module that is designated the “specific” communication module, each generic communication module comprising at least one antenna and being configured to communicate with said user equipment, the specific communication module being mounted at the center of the vehicle and comprising a first antenna designated the “left” antenna and a second antenna designated the “right” antenna, said left antenna being configured to radiate over 180° and cover the left-hand part of the vehicle, said right antenna being configured to radiate over 180° and cover the right-hand part of the vehicle, the specific communication module being configured to communicate with said user equipment, said vehicle being configured to:
receive a signal transmitted by the user equipment by means of at least two generic communication modules, including a first generic communication module and a second generic communication module,
estimate, for each generic communication module, a distance of the user equipment from the center of the vehicle,
calculate a quality index of the received signal for each generic communication module, including a first quality index of the signal received by the first generic communication module and a second quality index of the signal received by the second generic communication module,
receive, by means of the left antenna of the specific communication module, a signal sent by the user equipment,
calculate the strength of the signal received by the left antenna,
receive, by means of the right antenna of the specific communication module, a signal sent by the user equipment,
calculate the strength of the signal received by the right antenna,
if the strength of the received signal of the left antenna is greater than the strength of the received signal of the right antenna, weighting by a first coefficient the quality indices calculated for the one or more generic communication modules located in the left-hand part of the vehicle and weighting by a second coefficient the quality indices calculated for the one or more generic communication modules located in the right-hand part of the vehicle, the first coefficient being greater than the second coefficient,
if the strength of the received signal of the right antenna is greater than the strength of the received signal of the left antenna, weighting by the first coefficient the quality indices calculated for the one or more generic communication modules located in the right-hand part of the vehicle and weighting by the second coefficient the quality indices calculated for the one or more generic communication modules located in the left-hand part of the vehicle,
determine the location of the user equipment from the distances estimated for at least two generic communication modules, each distance being weighted by its corresponding weighted quality index.

Advantageously, the specific communication module is singular and mounted on the longitudinal axis of the vehicle, for example at the center of the vehicle.

As a variant, the specific communication module may be in two parts, each comprising at least one antenna and being mounted symmetrically with respect to the longitudinal axis of the vehicle, the radiation patterns of the antennas being the same and being oriented to the left and to the right of the vehicle, respectively, or indeed the specific communication module may even be in two parts, each comprising at least one antenna and being mounted asymmetrically with respect to the longitudinal axis of the vehicle, the radiation patterns of the antennas each being oriented to the left and to the right of the vehicle, respectively, and compensating for one another. These different configurations make it possible to achieve a balance between right/left distances, without which the signal could be identified as being stronger on one side despite a larger distance.

According to one aspect of the invention, each generic communication module comprises a single antenna.

Preferably, the first coefficient is equal to 1 and the second coefficient is equal to 0.5.

Also preferably, the vehicle is configured to determine the location of the user equipment by bilateration for two generic communication modules or by trilateration for three generic communication modules.

The invention also relates to a communication system comprising a vehicle such as described above and a user equipment configured to transmit signals intended for the generic communication modules and for the specific communication module of the vehicle.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates one embodiment of the system according to the invention.

FIG. 2 schematically illustrates one embodiment of the method according to the invention.

### DETAILED DESCRIPTION OF EXEMPLARY EMBODIMENTS

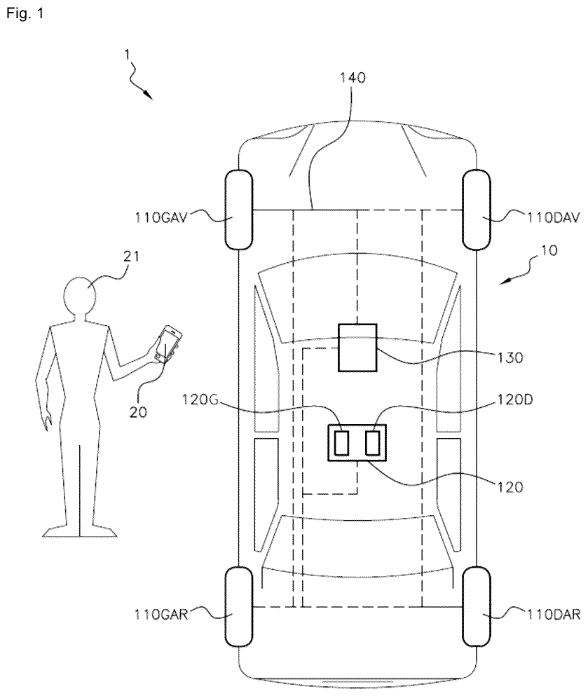

FIG. 1 illustrates one example of a system 1 according to an aspect of the invention.

The system 1 comprises a motor vehicle 10 and a user equipment 20.

The vehicle 10 comprises four communication modules designated the “generic” communication modules 110GAV, 110GAR, 110DAV, 110DAR, two of which 110GAV, 110GAR are mounted in the left-hand part of the vehicle, one generic communication module 110GAV at the front left and one generic communication module 110GAR at the rear left, and two of which 110DAV, 110DAR are mounted in the right-hand part of the vehicle, one generic communication module 110DAV at the front right and one generic communication module 110DAR at the rear right.

In this example, each generic communication module 110GAV, 110GAR, 110DAV, 110DAR comprises one antenna or a diversity of antennas and is configured to communicate with the user equipment 20, for example using the protocol Bluetooth or Ultra-Wide Band (UWB).

The vehicle 10 also comprises a communication module designated the “specific” communication module 120, mounted on the longitudinal axis of the vehicle 10.

In this example, the specific communication module 120 is mounted substantially at the center of the vehicle 1 and comprises a first antenna designated the “left” antenna 120G and a second antenna designated the “right” antenna 120D.

The left antenna 120G is configured to radiate over 180° and cover the left-hand part of the vehicle 10. The right antenna 120D is configured to radiate over 180° and cover the right-hand part of the vehicle 10.

The specific communication module 120 is configured to communicate with the user equipment, for example using the protocol Bluetooth or Ultra-Wide Band (UWB).

The vehicle 10 is configured to estimate, for each generic communication module 110GAV, 110GAR, 110DAV, 110DAR receiving signals from the user equipment 20 (i.e. lying within the radio coverage of the user equipment 20), a distance LGAV, LGAR, LDAV, LDAR of the user equipment 20 with respect to the center of the vehicle 10. The distance may be estimated by analyzing the phase variation between the transmitted signals and the received signals, in the context of the protocol BLE Channel Sounding.

This estimation of distance may be carried out by each of the generic communication modules 110GAV, 110GAR, 110DAV, 110DAR or by an electronic control unit 130 of the vehicle 10 with which each of the generic communication modules 110GAV, 110GAR, 110DAV, 110DAR is able to communicate, for example via a wired communication network 140 of the vehicle 10 or wirelessly via electromagnetic waves (for example radio-frequency waves or microwaves).

The vehicle 10 is configured to calculate, for each generic communication module 110GAV, 110GAR, 110DAV, 110DAR receiving signals from the user equipment 20, a quality index IQ_GAV, IQ_GAR, IQ_DAV, IQ_DAR of the signal received by each generic communication module 110GAV, 110GAR, 110DAV, 110DAR.

The vehicle 10 is configured to calculate the strength, preferably the received signal strength indicator (RSSI), of a signal transmitted by the user equipment 20 and received by the left antenna 120G and to calculate the strength (preferably the RSSI) of a signal transmitted by the user equipment 20 and received by the right antenna 120D.

The vehicle 10 is configured, when the strength of the received signal of the left antenna 120G is greater than the strength of the received signal of the right antenna 120D, to weight by a first coefficient C1 the quality indices IQ_GAV, IQ_GAR, IQ_DAV, IQ_DAR calculated for the generic communication modules 110GAV, 110GAR having received signals from the user equipment 20 and being located in the left-hand part of the vehicle 10 and to weight by a second coefficient C2 the quality indices calculated for the one or more generic communication modules 110DAV, 110DAR having received signals from the user equipment 20 and being located in the right-hand part of the vehicle, the first coefficient C1 being greater than the second coefficient C2. Preferably, the first coefficient C1 is equal to 1 and the second coefficient C2 is equal to 0.5.

The vehicle 10 is configured, when the strength of the received signal of the right antenna 120D is greater than the strength of the received signal of the left antenna 120G, to weight by the first coefficient C1 the quality indices IQ_DAV, IQ_DAR calculated for the generic communication modules 110DAV, 110DAR having received signals from the user equipment 20 and being located in the right-hand part of the vehicle 10 and to weight by the second coefficient C2 the quality indices IQ_GAV, IQ_GAR calculated for the generic communication modules 110GAV, 110GAR having received signals from the user equipment 20 and being located in the left-hand part of the vehicle 10.

The vehicle 10 is configured to determine the location of the user equipment 20 from the estimated distances, for example by bilateration or trilateration as known per se, for at least two generic communication modules 110GAV, 110GAR, 110DAV, 110DAR each weighted by the corresponding quality index thereof IQ_GAV, IQ_GAR, IQ_DAV, IQ_DAR, which is weighted beforehand by the first coefficient C1 (for the front left and rear left generic communication modules 110GAV, 110GAR) or the second coefficient C2 (for the front right generic communication module 10DAV).

Preferably, the vehicle 10 is configured to determine the location of the user equipment 20 by bilateration when only two generic communication modules 110GAV, 110GAR, 110DAV, 110DAR have received signals from the user equipment 20 or by trilateration when at least three generic communication modules 110GAV, 110GAR, 110DAV, 110DAR have received signals from the user equipment 20.

When they process data, in particular calculation data, the electronic control unit 130, each generic communication module 110GAV, 110GAR, 110DAV, 110DAR and the specific communication module 120 comprise a processor capable of implementing an instruction set allowing these functions to be performed.

### Example of Implementation

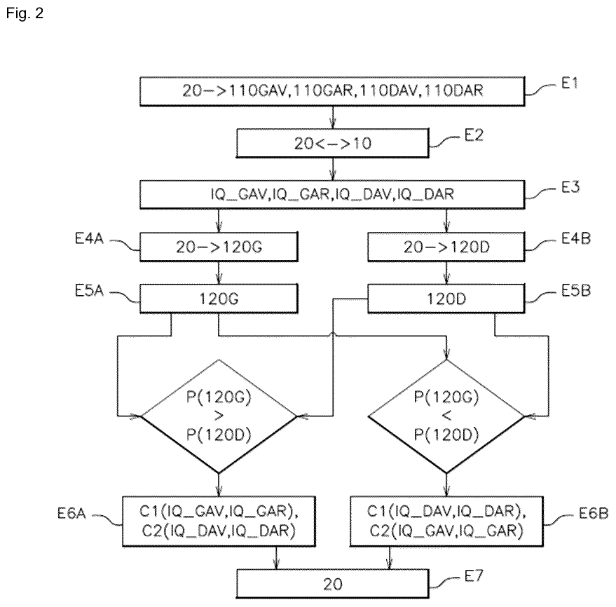

One example of implementation of an aspect of the invention will now be described with reference to FIG. 2.

In a step E1, at least two generic communication modules receive a signal transmitted by the user equipment 20. In the example of FIG. 1, the front left generic communication module 110GAV, the rear left generic communication module 110GAR, and the front right generic communication module 110DAV receive signals from the user equipment 20.

For each generic communication module 110GAV, 110GAR, 110DAV having received signals from the user equipment 20, a distance LGAV, LGAR, LDAV of the user equipment 20 is estimated from the center of the vehicle 10 in a step E2, by the generic communication module 110GAV, 110GAR, 110DAV itself or by the electronic control unit 130.

For each generic communication module 110GAV, 110GAR, 110DAV having received signals from the user equipment 20, a quality index IQ_GAV, IQ_GAR, IQ_DAV of the received signal is calculated in a step E3, by the generic communication module 110GAV, 110GAR, 110DAV itself or by the electronic control unit 130.

The left antenna 120G of the specific communication module 120 receives a signal sent by the user equipment 20 in a step E4A and then the strength of said signal received by the left antenna 120G is calculated in a step E5A, by the specific communication module 120 or by the electronic control unit 130.

The right antenna 120D of the specific communication module 120 receives a signal sent by the user equipment 20 in a step E4B and then the strength of said signal received by the right antenna 120D is calculated in a step E5B, by the specific communication module 120 or by the electronic control unit 130.

When the strength of the received signal of the left antenna 120G is greater than the strength of the received signal of the right antenna 120D, in a step E6A, the calculated quality indices IQ_GAV, IQ_GAR are weighted by the first coefficient C1 for the front left and rear left generic communication modules 110GAV, 110GAR having received signals from the user equipment 20 and being located in the left-hand part of the vehicle 10 and the quality index IQ_DAV calculated for the front right generic communication module 110DAV located in the right-hand part of the vehicle 10 is weighted by the second coefficient C2. These calculations may be carried out by the generic communication module 120 or by the electronic control unit 130.

When the strength of the received signal of the right antenna 120D is greater than the strength of the received signal of the left antenna 120G, in a step E6B, the quality index IQ_DAV calculated for the generic communication module 110DAV located in the right-hand part of the vehicle 10 is weighted by the first coefficient C1 and the quality indices IQ_GAV, IQ_GAR calculated for the generic communication modules 110GAV, 110GAR located in the left-hand part of the vehicle 1 are weighted by the second coefficient C2. Once again, these calculations may be carried out by the generic communication module 120 or by the electronic control unit 130.

Lastly, in a step E7, the user equipment 20 is located LUE through trilateration from the distances LGAV, LGAR, LDAV estimated for the three generic communication modules 110GAV, 110GAR, 110DAV each weighted by its corresponding quality index IQ_GAV, IQ_GAR, IQ_DAV, already weighted by its corresponding coefficient:

$$L U E = \frac{( C 1 \times LGAV + C 1 \times LGAR + C 2 \times LDAV )}{3} \qquad [ Math 1 ]$$

These calculations may be carried out by the generic communication module 120 or by the electronic control unit 130.

The invention therefore allows the quality indicators calculated for each generic communication module to be weighted depending on whether the user equipment 20 is to the left or to the right of the vehicle 10, in order to increase the weight of the estimated distance for the generic communication modules situated on the side of the user equipment 20 and thus improve the accuracy of the overall location of the user equipment 20.

1. A method for locating a user equipment around a motor vehicle, said vehicle comprising at least four communication modules designated the “generic” communication modules, at least two of which are mounted in the left-hand part of the vehicle and at least two of which are mounted in the right-hand part of the vehicle, and a communication module that is designated the “specific” communication module, each generic communication module comprising a single antenna and being configured to communicate with said user equipment, the specific communication module being mounted on the longitudinal axis of the vehicle and comprising a first antenna designated the “left” antenna and a second antenna designated the “right” antenna, said left antenna being configured to radiate over 180° and cover the left-hand part of the vehicle, said right antenna being configured to radiate over 180° and cover the right-hand part of the vehicle, the specific communication module being configured to communicate with said user equipment, said method comprising the steps of:
reception of a signal transmitted by the user equipment by at least two generic communication modules, including a first generic communication module and a second generic communication module,
estimation, for each generic communication module, of a distance of the user equipment from the center of the vehicle,
calculation of a quality index of the received signal for each generic communication module, including a first quality index of the signal received by the first generic communication module and a second quality index of the signal received by the second generic communication module,
reception, by the left antenna of the specific communication module, of a signal sent by the user equipment,
calculation of the strength of the signal received by the left antenna,
reception, by the right antenna of the specific communication module, of a signal sent by the user equipment,
calculation of the strength of the signal received by the right antenna,
if the strength of the received signal of the left antenna is greater than the strength of the received signal of the right antenna, weighting by a first coefficient the quality indices calculated for the one or more generic communication modules located in the left-hand part of the vehicle and weighting by a second coefficient the quality indices calculated for the one or more generic communication modules located in the right-hand part of the vehicle, the first coefficient being greater than the second coefficient,
if the strength of the received signal of the right antenna is greater than the strength of the received signal of the left antenna, weighting by the first coefficient the quality indices calculated for the one or more generic communication modules located in the right-hand part of the vehicle and weighting by the second coefficient the quality indices calculated for the one or more generic communication modules located in the left-hand part of the vehicle,
determination of the location of the user equipment from the distances estimated for at least two generic communication modules, each distance being weighted by its corresponding weighted quality index.

2. The method as claimed in claim 1, wherein the first coefficient is equal to 1 and the second coefficient is equal to 0.5.

3. The method as claimed in claim 1, wherein the location of the user equipment is determined by bilateration for two generic communication modules or by trilateration for three generic communication modules.

4. A computer program product, comprising a set of program code instructions that, when executed by one or more processors, configure the one or more processors to implement a method as claimed in claim 1.

5. A motor vehicle comprising at least four communication modules designated the “generic” communication modules, at least two of which are mounted in the left-hand part of the vehicle and at least two of which are mounted in the right-hand part of the vehicle, and a communication module that is designated the “specific” communication module, each generic communication module comprising a single antenna and being configured to communicate with said user equipment, the specific communication module being mounted at the center of the vehicle and comprising a first antenna designated the “left” antenna and a second antenna designated the “right” antenna, said left antenna being configured to radiate over 180° and cover the left-hand part of the vehicle, said right antenna being configured to radiate over 180° and cover the right-hand part of the vehicle, the specific communication module being configured to communicate with said user equipment, said vehicle being configured to:
receive a signal transmitted by the user equipment by at least two generic communication modules, including a first generic communication module and a second generic communication module,
estimate, for each generic communication module, a distance of the user equipment from the center of the vehicle,
calculate a quality index of the received signal for each generic communication module, including a first quality index of the signal received by the first generic communication module and a second quality index of the signal received by the second generic communication module,
receive, by the left antenna of the specific communication module, a signal sent by the user equipment,
calculate the strength of the signal received by the left antenna,
receive, by the right antenna of the specific communication module, a signal sent by the user equipment,
calculate the strength of the signal received by the right antenna,
if the strength of the received signal of the left antenna is greater than the strength of the received signal of the right antenna, weighting by a first coefficient the quality indices calculated for the one or more generic communication modules located in the left-hand part of the vehicle and weighting by a second coefficient the quality indices calculated for the one or more generic communication modules located in the right-hand part of the vehicle, the first coefficient being greater than the second coefficient,
if the strength of the received signal of the right antenna is greater than the strength of the received signal of the left antenna, weighting by the first coefficient the quality indices calculated for the one or more generic communication modules located in the right-hand part of the vehicle and weighting by the second coefficient the quality indices calculated for the one or more generic communication modules (110GAV, 110GAR) located in the left-hand part of the vehicle,
determine the location of the user equipment from the distances estimated for at least two generic communication modules, each distance being weighted by its corresponding weighted quality index.

6. The vehicle as claimed in claim 5, wherein the first coefficient is equal to 1 and the second coefficient is equal to 0.5.

7. The vehicle as claimed in claim 5, said vehicle being configured to determine the location of the user equipment by bilateration for two generic communication modules or by trilateration for three generic communication modules.

8. A communication system comprising a vehicle according to claim 5 and a user equipment configured to transmit signals intended for the generic communication modules and for the specific communication module of the vehicle.
